(19) United States
(12) Patent Application Publication
(10) Pub. No.: US 2026/0284832 A1
(43) Pub. Date: Sep. 24, 2026

(54) METHOD FOR PRODUCING A THREADED NUT OF A ROLLING-ELEMENT SCREW DRIVE

(71) Applicant: Schaeffler Technologies AG & Co. KG, Herzogenaurach (DE)

(72) Inventors: Richard Baier, Aurachtal (DE); Mario Kreutzer, Sonneberg (DE); Dieter Adler, Herzogenaurach (DE)

(73) Assignee: Schaeffler Technologies AG & Co. KG, Herzogenaurach (DE)

(21) Appl. No.: 19/168,815

(22) PCT Filed: Feb. 8, 2024
(86) PCT No.: PCT/DE2024/100111

§ 371 Date: Sep. 25, 2025

(30) Foreign Application Priority Data
Mar. 27, 2023 (DE) 10 2023 107 595.0

(51) Int. Cl. B24C 1/04; F16H 25/22; F16H 25/24

(52) U.S. Cl. CPC B24C 1/045; F16H 25/2214; F16H 2025/2481

(57) ABSTRACT

The disclosure relates to a method for producing a threaded nut of a ball screw drive. The threaded nut has holes distributed across the circumference for receiving deflector pieces. The holes are produced via fluid-jet cutting according to the following steps:

a protective lining provided with multiple lining holes is inserted into the threaded nut, and the lining holes are aligned with hole positions on the threaded nut which are provided for the formation of the holes,

a cutting jet from the cutting tool is directed radially from the outside, at the hole positions provided, towards a lateral surface of the threaded nut,

the cutting jet penetrates the lateral surface of the threaded nut and the lining hole in the protective lining, and

after the hole has been formed by means of the cutting jet, the protective lining and the threaded nut are separated from one another.

### CROSS-REFERENCE TO RELATED APPLICATIONS

This application is the U.S. National Phase of PCT Application No. PCT/DE2024/100111 filed on Feb. 8, 2024, which claims priority to DE 10 2023 107 595.0 filed on Mar. 27, 2023, the entire disclosures of which are incorporated by reference herein.

### TECHNICAL FIELD

The present disclosure relates to a method for producing a threaded nut of a rolling-element screw drive, in particular a ball screw drive, and to a rolling-element screw drive.

### BACKGROUND

A rolling-element screw drive underlying the disclosure is provided with a threaded nut arranged on a threaded spindle. A relative screwing movement of the threaded spindle and the threaded nut is converted into a translational displacement of the threaded spindle and the threaded nut relative to one another.

Rolling elements—for example balls—move along helical grooves wound around the spindle axis—for example ball grooves—which are formed on the inner circumference of the threaded nut and on the outer circumference of the threaded spindle.

The rolling elements circulate in endless channels, for example balls in endless ball tracks. These channels each have a load section wound helically around a spindle axis and a deflector section connecting a beginning to an end of the load section. The load section is formed by the grooves of the threaded nut and the threaded spindle. The deflector sections are each formed on a deflector piece that engages in a hole in the threaded nut.

For example, a ball screw drive is disclosed in publication DE102004004145 B3, the holes of which are milled into the threaded nut. The burrs resulting from this machining process must be removed in an additional step.

### SUMMARY

The object of the disclosure is to provide a method for simplifying the production of holes in threaded nuts.

According to the disclosure, this object has been achieved according to the features described herein.

The threaded nut of the rolling-element screw drive has holes arranged distributed over the circumference for receiving deflector pieces, which holes are produced by means of fluid-jet cutting using a cutting tool.

The cutting means is a fluid that can be formed by an oil. In an example embodiment, water is the cutting means, to which abrasive additives such as sand or corundum are added.

The so-called water-jet cutting of materials is a production method that belongs to the main group of cutting processes. It is assigned to the group of abrasive methods. The material removal in water-jet cutting is based on the high pressure and resulting high speed of the cutting jet directed at the surface of the workpiece. The fine cutting jet allows for very delicate and complex contours to be cut.

An abrasive agent can be added to the water in order to produce the holes. In this case, the cutting means is made from a mixture containing water and an abrasive substance such as sand, for example garnet or olivine sand, and sometimes corundum. Abrasive cutting in particular can be used for machining workpieces made of steel and is well suited to the present disclosure.

The holes can be produced using a cutting jet after a groove has been provided on the inner circumference of the threaded nut, wound helically around a spindle axis of the ball screw drive. The threaded nut provided with the groove may already be hardened and ground. The method according to the disclosure for producing the holes in the wall of the threaded nut uses a cutting jet to prevent unwanted burr formation on the threaded nut.

However, it may be useful—for example, in the case of a milled thread—to form the holes before this groove is formed on the inner circumference of the threaded nut.

In order to produce the holes, a protective lining, which is provided with a plurality of lining holes over the circumference of its lateral surface, is first inserted into the threaded nut, which lining holes are aligned with respect to the threaded nut at hole positions at which the holes are to be introduced into the threaded nut. The threaded nut and protective lining are positioned relative to one another in the cutting tool accordingly.

The protective lining can be arranged in the cutting tool and the threaded nut is pushed onto the protective lining.

The lining holes can limit the contour along which the cutting jet later penetrates the wall thickness of the hole to later receive the deflector piece. In this case, the lining holes can be congruent with the holes in the wall of the threaded nut.

The lining holes can be larger than the holes provided in the wall of the threaded nut. This makes it easier to position the protective lining in the threaded nut.

A particularly advantageous variant provides for the protective lining to be fixed in the tool and arranged in a fixed position relative to the cutting nozzle(s) of the tool. The lining holes can therefore be designed small enough that the cutting jet can easily pass through them. During cutting, the threaded nut is moved in the tool, i.e., relative to the protective lining and the cutting jet. During the cutting process, the threaded nut can be displaced relative to the cutting jet and the protective lining. The displacement can comprise an axial displacement and a change in the angular position of the threaded nut in the cutting tool. This displacement is carried out in such a way that the cutting jet can cut out the desired hole. This sequence of movements is similar to that used in fretwork, where the workpiece is also intended to be displaced relative to the tool.

The groove can be already formed on the threaded nut before the holes are cut into the threaded nut.

The protective lining can rest against the inner circumference of the inner lateral surface of the threaded nut with its outer lateral surface. The protective lining can be formed by a sleeve with an outer contour adapted to the inner contour of the threaded nut.

The protective lining can be designed as a smooth cylindrical sleeve and rest against the inner lateral surface of the threaded nut. If the ball groove is already formed on the threaded nut, the smooth cylindrical sleeve can only contact the thread tips of the ball groove of the threaded nut.

The sleeve can be provided on its outer circumference with an external thread wound helically around the sleeve axis, and the threaded nut can be provided with a groove wound helically around the nut axis, into which the external thread of the sleeve engages. The protective lining can therefore be designed as a threaded sleeve, the thread of which traces the helical groove of the threaded nut. In this case, the threaded sleeve can be screwed into the threaded nut.

The grooves of the threaded nut are well protected with this threaded sleeve. In this variant, the protective lining and the cutting nozzle are not fixed in relation to one another. Rather, there is a relative movement of the threaded nut together with the protective sleeve in relation to the cutting jet. In this case, the cutting jet is moved axially or at an angle to the protective lining. This means that either a slot or an enlarged hole is required in the protective lining so that the cutting jet can pass through the protective lining unhindered.

The protective lining is positioned in the threaded nut. A cutting jet from the cutting tool is directed radially from the outside onto a lateral surface of the threaded nut at the intended hole positions. The cutting jet cuts through the wall of the threaded nut, removing material from the threaded nut and finally penetrates the lining hole of the protective lining unimpeded.

Once the cutting jet has produced the hole in the threaded nut, it strikes the opposite lateral surface of the protective lining. The protective lining prevents the cutting jet from striking the inner lateral surface of the threaded nut and damaging the groove that has already been formed there. The holes on the threaded nut can be arranged such that a cutting jet does not strike another lining hole.

The protective lining covers the areas on the inner circumference of the threaded nut that are exposed to the cutting jet when it has cut through the wall of the threaded nut and strikes the opposite side of the inner lateral surface of the threaded nut. This protects any groove that may already have been produced on the inner circumference of the threaded nut.

After the hole has been formed by means of the cutting jet, the protective lining and the threaded nut are separated from one another. For example, the threaded nut can be moved out of the tool while the protective lining remains in the tool. Further machining of the holes can be omitted. Removed material is washed away with the cutting jet.

The threaded nut with the protective lining can additionally be exposed to a fluid flow, in particular a water flow, which flows through the protective lining under the cutting jet. The cutting jet hits this water flow, is slowed down and deflected toward an end face of the threaded nut or fanned out. This reliably prevents unwanted stress on the protective lining caused by the cutting jet. The material removed from the threaded nut is washed away by the fluid flow.

The cutting jet can be brought into different jet positions in its jet direction relative to the threaded nut in order to form hole walls of the threaded nut which are formed at an angle to the threaded nut axis. This allows for complex hole walls to be produced. These different jet positions can be achieved, for example, by changing the angular position of the threaded nut in the cutting tool.

An equal number of cutting jets can be provided according to the number of hole positions. This allows for all holes to be produced at the same time.

The shape and size of the lining holes in the protective lining can be as described, depending on the desired shaping of the holes in the threaded nut and the arrangement of the workpiece and the protective lining in the tool.

A ball screw drive provided according to the method of the disclosure is provided with a threaded nut arranged on a threaded spindle and with balls circulating in endless ball tracks, which each have a load section wound helically around a spindle axis and a deflector section connecting a beginning to an end of the load section. The load section is formed by ball grooves wound helically around the spindle axis on the inner circumference of the threaded nut and on the outer circumference of the threaded spindle. The deflector section is formed on a deflector piece which is inserted into one of the holes of the threaded nut, which are produced according to the method according to the disclosure and its expedient further developments.

### BRIEF DESCRIPTION OF THE DRAWINGS

The disclosure is explained in more detail below with reference to an exemplary embodiment shown in a total of five figures. In the drawings:

FIG. 1 shows a schematic representation of a cutting tool with an inserted threaded nut of a ball screw drive,

FIG. 2 shows an enlarged detailed view of FIG. 1,

FIG. 3 shows a section of a ball screw drive in a perspective representation,

FIG. 4 shows a longitudinal section through a threaded nut of the ball screw drive of FIG. 3, and

FIG. 5 shows a perspective representation of the threaded nut of the ball screw drive of FIG. 3.

### DETAILED DESCRIPTION

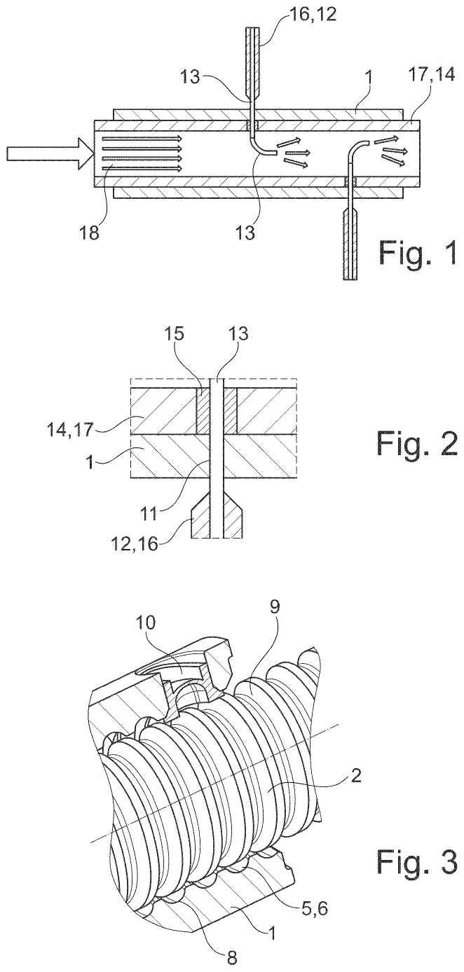

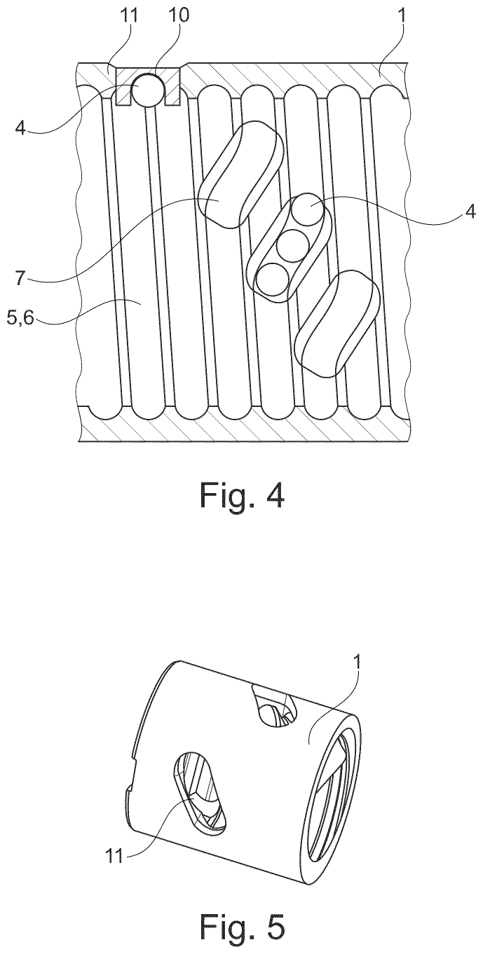

FIG. 1 shows a schematic representation of a method for producing a threaded nut 1 of a rolling-element screw drive designed as a ball screw drive, the essential components of which are first explained on the basis of FIGS. 3 to 5.

The ball screw drive is provided with a threaded nut 1 arranged on a threaded spindle 2. Rolling elements designed as balls 4 circulate in endless channels, which are designed as ball tracks 5. The ball tracks 5 each have a load section 6 wound helically around a spindle axis and a deflector section 7 connecting a beginning to an end of the load section 6. The load section 6 is formed by grooves wound helically around the spindle axis, which are designed as ball grooves 8, 9 on the inner circumference of the threaded nut 1 and on the outer circumference of the threaded spindle 2. The deflector section 7 is formed on a deflector piece 10. The threaded nut 1 has holes 11 arranged distributed over the circumference in order to receive the deflector pieces 10. One deflector piece 10 is inserted into each of the holes 11.

The holes 11 are produced by means of water-jet cutting. In the exemplary embodiment, a cutting tool 12 is used, the cutting jet 13 of which is provided by a water jet with an added abrasive agent such as sand or corundum.

Before the cutting process begins, the threaded nut 1, which is already provided with the ball groove 8, is inserted into a holder of the cutting tool 12 (not shown further) and held in place therein.

A protective lining 14, which is provided with a plurality of lining holes 15 over the circumference of its lateral surface, is inserted into the threaded nut 1, which lining holes are aligned with respect to the threaded nut 1 at hole positions at which the holes 11 are to be introduced into the threaded nut 1. The protective lining 14 is fixed relative to the cutting jet 13 in the cutting tool 12. The threaded nut 1 is moved in the cutting tool 12 relative to the protective lining 14 both in the axial direction and with respect to its angular position. The advantage of this variant is that only a small hole is required in the protective lining 14 for the cutting jet 13.

In the exemplary embodiment, the protective lining 14 is provided with a sleeve 17 having an outer contour adapted to the inner contour of the threaded nut 1. The sleeve 17 can either be provided with an external thread wound helically around the sleeve axis, which engages in the helically wound ball groove 8 of the threaded nut 1, or it can also be designed as a smooth cylinder.

Cutting nozzles 16 of the cutting tool 12 are directed radially from the outside onto a lateral surface of the threaded nut 1 at the intended hole positions where the holes 11 are to be produced. An equal number or quantity of cutting nozzles 16 is provided according to the number or quantity of hole positions.

The cutting jet 13 penetrates the wall of the threaded nut 1 and the lining hole 15. The lining hole 15 can be large enough so that the hole to be cut in the wall of the threaded nut 1 lies completely within the lining hole 15. The cutting jet 13 strikes the opposite lateral surface of the protective lining 14 and is deflected.

During the process described, in this exemplary embodiment, a relative movement takes place between the cutting nozzles 16 and the threaded nut 1 while the holes are being formed. The threaded nut 1 can be moved in the tool holder (not shown) for this purpose.

In addition, the threaded nut 1 is exposed to a water flow 18 which flows in the axial direction through the threaded nut 1 and thus through the protective lining 14. The protective lining 14 can be arranged so close to the inner circumference of the threaded nut 1 that this water flow 18 flows exclusively through the protective lining 14. The water flow 18 assists in the deflection of the cutting jet 13, which strikes the water flow 18 and is deflected toward an end face of the threaded nut 1.

After forming the holes 11 using the cutting jet 13, the protective lining 14 and the threaded nut 1 are separated from one another.

### LIST OF REFERENCE SYMBOLS

1 Threaded nut
2 Threaded spindle
4 Ball
5 Ball track
6 Load section
7 Deflector section
8 Ball groove
9 Ball groove
10 Deflector piece
11 Hole
12 Cutting tool
13 Cutting jet
14 Protective lining
15 Lining hole
16 Cutting nozzle
17 Sleeve
18 Water flow

1. A method for producing at least one hole of a threaded nut of a rolling-element screw drive, the at least one hole arranged on the circumference of the threaded nut and configured for receiving a deflector piece, the at least one hole produced via fluid-jet cutting of a cutting tool according to the following steps:
inserting a protective lining into the threaded nut, a circumference of a lateral surface of the protective lining having at least one lining hole, each one of the at least one lining hole aligned with a corresponding one of an intended hole position of the at least one hole of the threaded nut,
directing a cutting jet of the cutting tool radially from outside of the threaded nut onto a lateral surface of the threaded nut at one of the intended hole positions,
penetrating both: i) a wall of the threaded nut, so as to form one of the at least one hole, and ii) one of the at least one lining hole of the protective lining, via the cutting jet, and
after the one of the at least one hole has been formed in the threaded nut via the cutting jet, separating the protective lining and the threaded nut.

2. The method according to claim 1, wherein the threaded nut is exposed to a fluid flow which flows in an axial direction through the threaded nut, and the fluid flow deflects the cutting jet toward an end face of the threaded nut.

3. The method according to claim 1, wherein the cutting jet is brought into different jet positions in its jet direction so as to form a wall of one of the at least one hole at an angle to a threaded nut axis.

4. The method according to claim 1, wherein a quantity of cutting nozzles of the cutting tool is equal to a quantity of the at least one hole of the threaded nut.

5. The method according to claim 1, wherein the at least one lining hole is congruent with or larger than a corresponding one of the at least one hole of the threaded nut.

6. The method according to claim 1, wherein the at least one lining hole is smaller than a corresponding one of the at least one hole of the threaded nut.

7. The method according to claim 1, wherein the threaded nut has a groove formed on the inner circumference and wound helically around a longitudinal axis of the threaded nut before the protective lining is inserted into the threaded nut.

8. The method according to claim 1, wherein the protective lining is defined by a sleeve and includes an external thread wound helically around a sleeve axis, and the external thread engages a groove of the threaded nut, the groove wound helically around a threaded nut axis.

9. The method according to claim 1, wherein the fluid-jet cutting is provided via a water jet with a mixture containing water and an abrasive substance.

10. A ball screw drive, comprising:
a threaded nut arranged on a threaded spindle,
balls configured to circulate in endless ball tracks, each of the endless ball tracks having a load section wound helically around a spindle axis and a deflector section which connects a beginning to an end of the load section, and
the load section is formed by ball grooves wound helically around the spindle axis on the inner circumference of the threaded nut and on the outer circumference of the threaded spindle, and
the deflector section is formed on a deflector piece which is inserted into one of at least one hole of the threaded nut, the one of the at least one hole produced according to the method of claim 1.

11. The method according to claim 7, wherein the protective lining covers an inner lateral surface of the threaded nut at an opposite location within the threaded nut of where the cutting jet has cut through the wall of the threaded nut.

12. The method according to claim 9, wherein the abrasive substance is sand or corundum.

13. A method for producing at least one hole of a threaded nut of a rolling-element screw drive via fluid-jet cutting, the method comprising:
inserting a protective lining into the threaded nut, a circumference of a lateral surface of the protective lining having at least one lining hole, each one of the at least one lining hole aligned with a corresponding one of an intended hole position of the at least one hole of the threaded nut,
directing a cutting jet of a fluid-jet cutting tool radially from outside of the threaded nut onto a lateral surface of the threaded nut at one of the intended hole positions,
penetrating both: i) a wall of the threaded nut, so as to form one of the at least one hole, and ii) one of the at least one lining hole of the protective lining, via the cutting jet, and
after the one of the at least one hole has been formed in the threaded nut via the cutting jet, separating the protective lining and the threaded nut.

14. The method according to claim 13, wherein the threaded nut has a groove formed on the inner circumference and wound helically around a longitudinal axis of the threaded nut before the protective lining is inserted into the threaded nut.

15. The method according to claim 13, wherein the protective lining is a sleeve disposed inside of the threaded nut.

16. The method according to claim 15, wherein the sleeve includes an external thread wound helically around a sleeve axis, and the external thread engages a groove of the threaded nut, the groove wound helically around a threaded nut axis.

17. A method for producing at least one hole of a threaded nut of a rolling-element screw drive via fluid-jet cutting, the method comprising:
inserting a protective sleeve into the threaded nut, the protective sleeve having at least one lining hole.
directing a cutting jet of a fluid-jet cutting tool radially from outside of the threaded nut at a position on a lateral surface of the threaded nut, the position on the lateral surface corresponding to a position of one of the at least one lining hole,
penetrating both: i) a wall of the threaded nut, so as to form one of the at least one hole, and ii) one of the at least one lining hole of the protective sleeve, via the cutting jet, and
after the one of the at least one hole has been formed in the threaded nut via the cutting jet, removing the protective sleeve from the threaded nut.

18. The method according to claim 17, wherein an outer contour of the protective sleeve is adapted to an inner contour of the threaded nut.
